(19) United States
(12) Patent Application Publication
(10) Pub. No.: US 2013/0121802 A1
(43) Pub. Date: May 16, 2013

(54) Wafer Transport Cart

(71) Applicants: Peter D. Albrecht, O'Fallon, MO (US); Vandan Tanna, Dardenne Prairie, MO (US)

(72) Inventors: Peter D. Albrecht, O'Fallon, MO (US); Vandan Tanna, Dardenne Prairie, MO (US)

(73) Assignee: MEMC ELECTRONIC MATERIALS, INC., St. Peters, MO (US)

(21) Appl. No.: 13/295,715

(22) Filed: Nov. 14, 2011

(51) Int. Cl. B62B 5/00; B65G 65/00

(52) U.S. Cl. 414/809; 280/79.3

(57) ABSTRACT

Systems and methods are disclosed for transporting wafers to a processing apparatus. The system comprises a frame having a support sized for receiving a wafer assembly including the wafers. An alignment system is connected to the frame. The alignment system is disposed for guiding the wafer assembly to a first position as the wafer assembly is lowered onto the support of the frame. The alignment system reduces the amount of time required to transport the wafers to the processing apparatus.

### FIELD

This disclosure relates generally to a wafer transport system and, more specifically, to systems used to transport wafers between a wire saw and a processing apparatus.

### BACKGROUND

Semiconductor wafers are typically formed by cutting an ingot with a wire saw machine. These ingots are typically made of silicon or other semiconductor or solar grade material. The ingot is connected to structure of the wire saw by a bond beam and an ingot holder. The ingot is bonded with adhesive to the bond beam, and the bond beam is in turn bonded with adhesive to the ingot holder. The ingot holder is connected by any suitable fastening system to the wire saw structure.

In operation, the ingot is contacted by a web of moving wires in the wire saw that slice the ingot into a plurality of wafers. The bond beam is then connected to a hoist and the wafers are lowered onto a cart. The wafers are then lowered into a liquid-filled tank that is incorporated into the cart. The cart includes a lifting mechanism to lower the wafers into the tank. The cart is then moved to a position adjacent a processing apparatus (e.g., a cleaner) and the wafers are raised by the lifting mechanism. The wafers are then pushed off of the cart and into the processing apparatus.

Known carts have numerous disadvantages, such as the weight of the cart due to the liquid-filled tank and housekeeping problems caused by the liquid spilling onto the floor when moving the cart. Other disadvantages include a lack of alignment aids to facilitate the loading of the wafers onto the cart without damaging the edges of the wafers. Thus, there exists a need for a more efficient and effective system to transport the wafers from the wire saw to the processing apparatus.

This section is intended to introduce the reader to various aspects of art that may be related to various aspects of the disclosure, which are described and/or claimed below. This discussion is believed to be helpful in providing the reader with background information to facilitate a better understanding of the various aspects of the present invention. Accordingly, it should be understood that these statements are to be read in this light, and not as admissions of prior art.

### SUMMARY

A first aspect is a cart for transporting wafers from a wire saw to a processing apparatus after the wafers are cut from an ingot. The cart comprises a frame having opposing ends and a support sized for receiving a wafer assembly including the wafers, rollers positioned in the support, and an upright member connected to one of the ends of the frame. The rollers have opposing ends connected to the frame and a tapered portion positioned adjacent the ends for guiding the wafer assembly to a first position as the wafer assembly is lowered onto the support of the frame. The upright member has an alignment member disposed for guiding the wafer assembly to the first position as the wafer assembly is placed on the support of the frame.

Another aspect is a system for transporting wafers to a processing apparatus. The system comprises a frame and an alignment system. The frame has a support sized for receiving a wafer assembly including the wafers. The alignment system is connected to the frame and is disposed for guiding the wafer assembly to a first position as the wafer assembly is lowered onto the support of the frame.

Still another aspect is a method of positioning a wafer assembly in a first position on a cart for transporting the wafer assembly from a wire saw to a processing apparatus, the wafer assembly including wafers cut from an ingot by the wire saw. The method comprises lowering the wafer assembly into contact with an alignment member connected to an upright member of the cart, the alignment member disposed for guiding the wafer assembly to the first position as the wafer assembly is lowered towards the frame, and placing the wafer assembly onto rollers connected to the frame, the rollers having a tapered portion for guiding the wafer assembly.

Various refinements exist of the features noted in relation to the above-mentioned aspects. Further features may also be incorporated in the above-mentioned aspects as well. These refinements and additional features may exist individually or in any combination. For instance, various features discussed below in relation to any of the illustrated embodiments may be incorporated into any of the above-described aspects, alone or in any combination.

### BRIEF DESCRIPTION OF THE DRAWINGS

FIG. 1 is a perspective view of a cart for transporting a wafer assembly;

FIG. 2 is a side view of the cart of FIG. 1;

FIG. 3 is a back view of the cart of FIG. 1;

FIG. 4 is a front view of the cart of FIG. 1;

FIG. 5 is a top plan view of the cart of FIG. 1 with a wafer cassette omitted;

FIG. 6 is an enlarged view of a portion of the cart of FIG. 5; and

FIG. 7 is a perspective view of the cart of FIG. 1 and a plate used to position the cart adjacent a processing apparatus.

Corresponding reference characters indicate corresponding parts throughout the several views of the drawings.

### DETAILED DESCRIPTION OF THE INVENTION

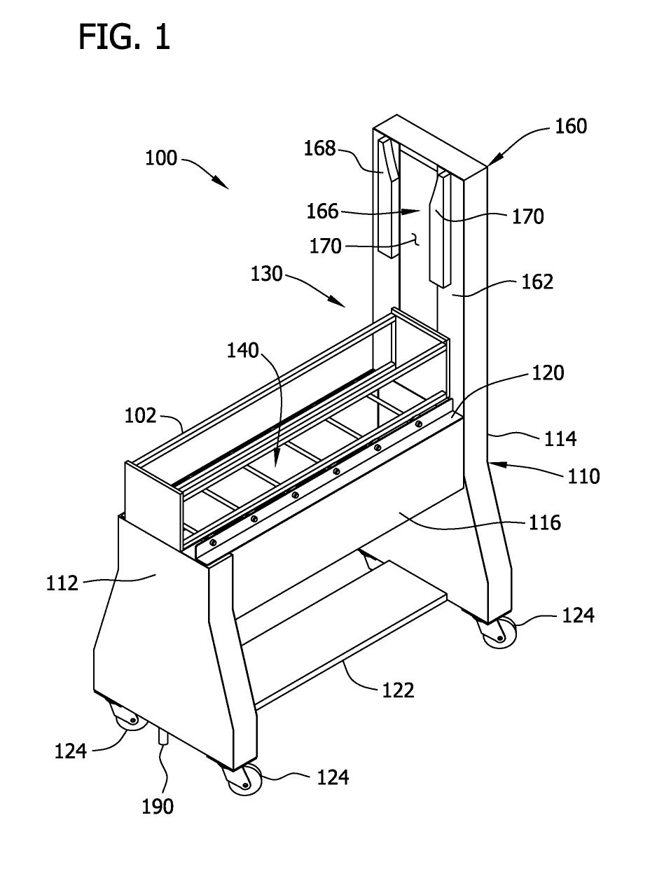

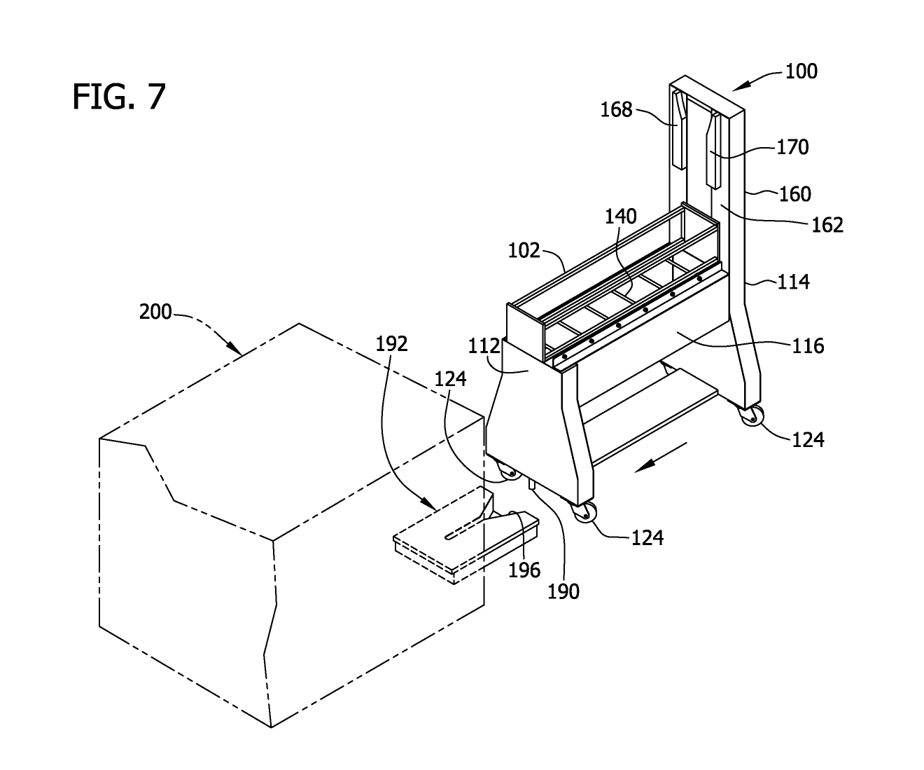

Referring to the drawings, an exemplary cart for transporting wafers to a processing apparatus after the wafers are cut from an ingot is shown in FIG. 1 and generally indicated at 100. The wafers and their accompanying support structure (e.g., a bond beam) are referred to herein as a wafer assembly. The wafer assembly may also include a cassette 102 into which the wafers and all or a portion of their accompanying support structure are placed. The processing apparatus (indicated generally at 200 in FIG. 7) in the example embodiment is an apparatus that cleans the wafers, although the cart 100 may also be used to transport the wafers to any other apparatus and/or location. Generally, the cart 100 described herein has features which aid in alignment of the wafer assembly with respect to the cart and alignment of the cart with respect to the processing apparatus 200.

The cart 100 includes a frame 110 having a support 120 sized for receiving the wafer assembly. The support 120 forms a top of the cart 100. The frame also has opposing ends (i.e., a first end 112 and a second end 114) connected by a pair of spaced-apart sides 116, 118. The frame 110 has a bottom 122 positioned opposite the support 120. In the example embodiment, four wheels 124 are connected to the bottom 122 of the frame 110 so that the cart 100 can be moved easily by a user. Some or all of these wheels 124 may be casters in the example embodiment. As described in greater detail below, the first end 112 of the cart 100 is configured for placement adjacent the processing apparatus 200.

An alignment system 130 is connected to the frame 110 and is disposed to guide the wafer assembly to a first position as the assembly is lowered onto the support 120 of the frame 110. In the first position, the wafer assembly is at rest on the support 110. In a second position, the wafer assembly is spaced from the support 110. In the example embodiment, the alignment system 130 includes rollers 140 and an upright member 160. In other embodiments only one of these may be used to guide the wafer assembly to the first position.

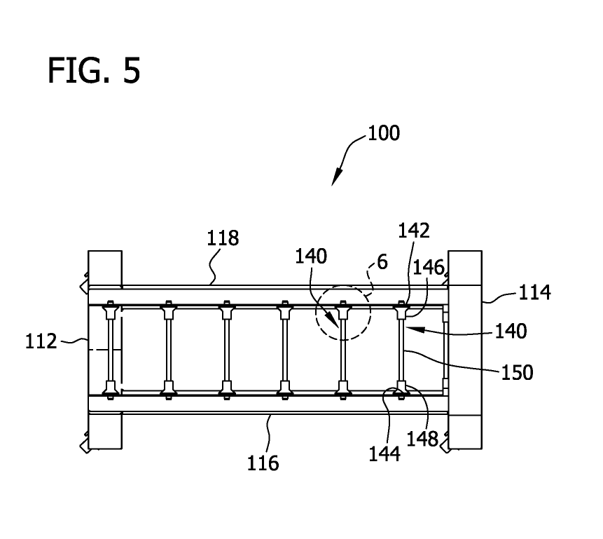

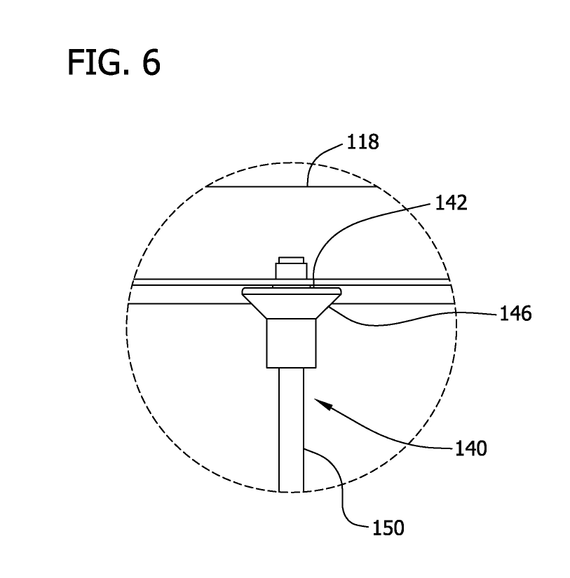

The rollers 140, as best seen in FIGS. 5 and 6, each have a first end 142 and an opposing, second end 144. Each of the ends 142, 144 is connected to the sides 116, 118 of the frame 110 such that the rollers 140 are positioned in the support 120. The ends 142, 144 of the rollers 140 are connected to the frame 110 by bearings in the example embodiment such that the rollers can rotate with respect to the frame. In other embodiments different devices may be used to connect the ends 142, 144 to the frame 110 (e.g., bushings).

As shown in FIG. 6, each roller 140 has a first tapered portion 146 disposed adjacent its first end 142 and a second tapered portion 148 disposed adjacent its second end 144. A middle portion 150 connects these tapered portions 146, 148. The diameter of the rollers 140 at their first and second ends 142, 144 is greater than their diameter at the middle portions 150. The tapered portions 146, 148 have a slope that is disposed to elevate a bottom of the wafer assembly above the middle portion 150 of the rollers 140 when the assembly is in the first position. That is, the tapered portions 146, 148 and their respective slopes are disposed to support the edges of the wafer assembly such that the wafer assembly does not contact the middle portions 150. Moreover, tapered portions 146, 148 and their slopes are also disposed such that a bottom of the wafer assembly is spaced a distance from the middle portions 150. This distance is such that any protrusions or other structures depending from the bottom of the wafer assembly do not contact the middle portions 150 of the rollers 140.

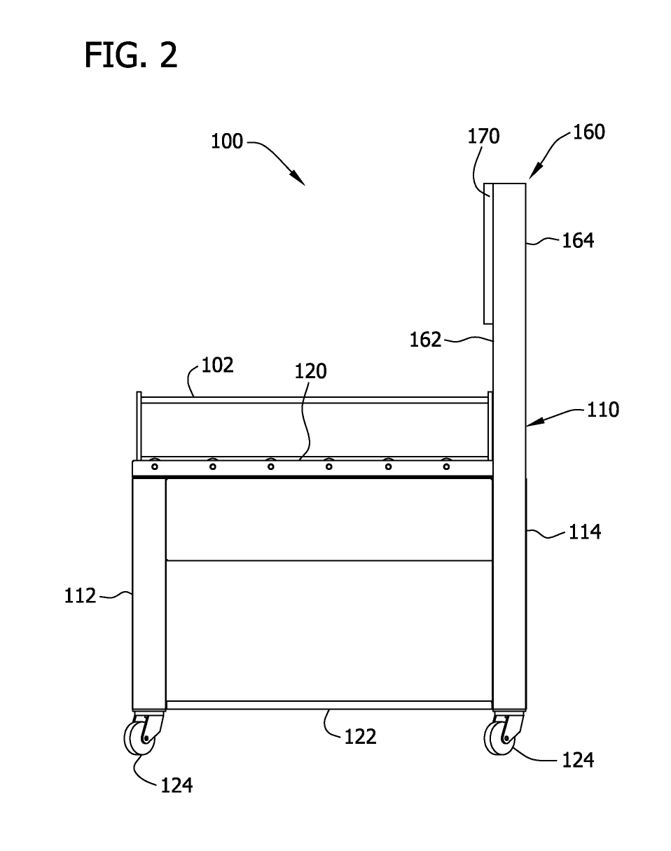

The upright member 160 is best shown in FIG. 1-4 and extends upward from the support 120 of the cart 100 adjacent the second end 114 of the cart. The upright member 160 has an inner side 162 disposed nearer to the first end 112 of the cart 100 and an opposing outer side 164. An alignment member 166 is connected to the inner side 162 of the upright member 160 by any suitable fastening system (e.g., mechanical fasteners). The alignment member 166 includes a first guide 168 and a second guide 170.

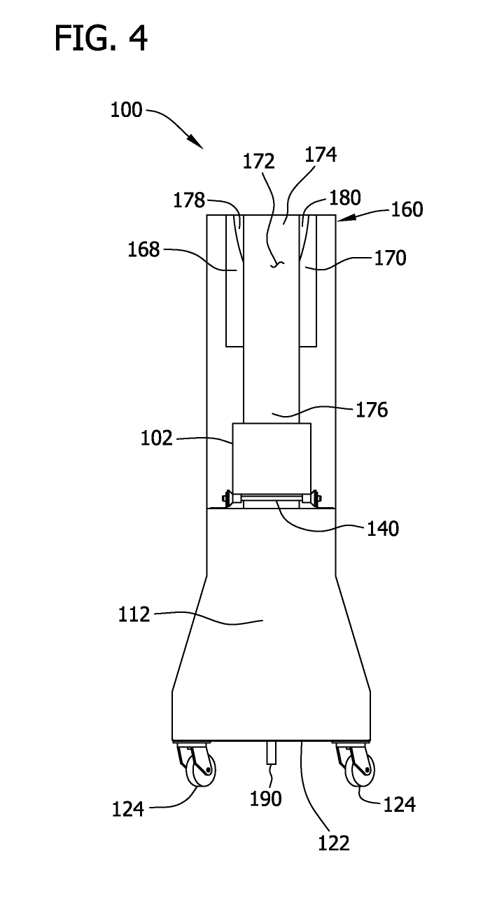

The guides 168, 170 and the upright member 160 form a channel 172 (best shown in FIG. 4) that receives a portion of a mobile hoist connected to the wafer assembly as it is lowered into the first position. The channel 172 has a first end 174 and a second end 176 and the first end is disposed farther away from the frame 110 than the second end. A width of the channel 172 at its first end 174 is greater than a width of the channel at its second end 176. That is, the width of the channel 172 is tapered. Moreover, the width of the channel 172 at the first end 174 is substantially greater (e.g., one inch or more) than the width of the portion of the mobile hoist received therein. The width of the channel at the second end 176 is only slightly greater than that of the mobile hoist (e.g., about 2 to 3 mm). The decreasing width of the channel 172 from the first end 174 to the second end 176 aids in the lateral positioning of the wafer assembly with respect to the support 120 and the cart 100.

The varying width of the channel 172 results from each guide 168, 170 having an angled portion 178, 180. In the example embodiment, these angled portions 178, 180 extend along less than all of the length of the guides 168, 170. In other embodiments, the angled portions 178, 180 extend from the first end 174 of the channel 172 to the second end 176 of the channel 172. In these embodiments, the guides 168, 170 are triangle-shaped.

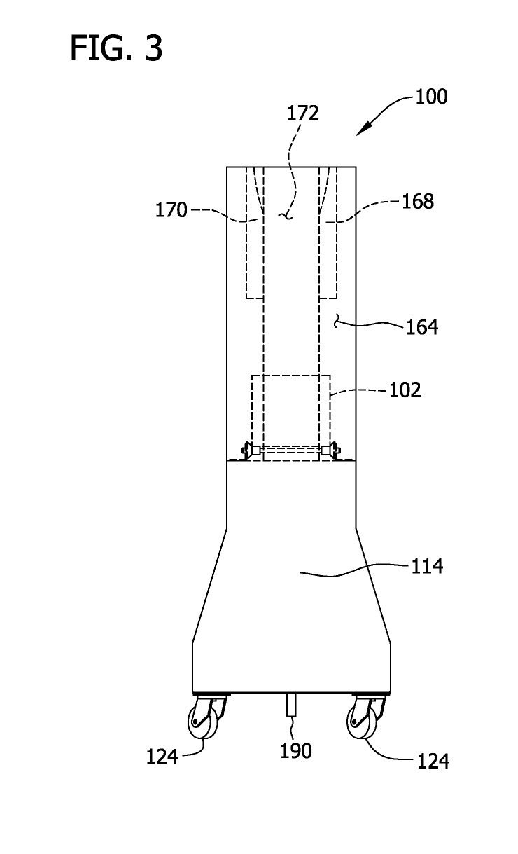

A pin 190, as best shown in FIGS. 3 and 7, protrudes from the bottom 122 of the cart 100 adjacent the second end 114 of the frame 110 of the cart 100. As described in greater detail below, the pin 190 is disposed to aid in positioning the cart 100 adjacent the processing apparatus 200 and/or the mobile hoist. The pin 190 protrudes from the cart 100 a distance that is less than a height of the wheels 124 (i.e., the pin does not interfere with the underlying surface on which the cart 100 is disposed).

A plate 192 is positioned on the underlying surface adjacent the processing apparatus 200, as shown in FIG. 7. In other embodiments, the plate 192 may be positioned in a recess formed in the underlying surface. Moreover, in the example embodiment another plate 192 is connected to the mobile hoist to aid in positioning of the cart 100 adjacent the mobile hoist.

The plate 192 has a slot 194 sized for receiving the pin 190 such that the slot in the plate and pin cooperate to position that cart 100 adjacent the processing apparatus 200 in an unloading position. The slot 194 has a tapered portion 196 disposed away from the processing apparatus 200 having a width substantially greater than that of the pin 190. The width of the tapered portion 196 decreases nearer the processing apparatus 200 to a width that is only slightly greater than that of the pin 190 (e.g., about 2 to 3 mm).

In operation, the wafer assembly is removed from the wire saw after the ingot is cut into wafers by the saw. The wafer assembly may be attached to a mobile hoist or other suitable structure before or after removal from the wire saw. The mobile hoist is then used to transport the wafer assembly to a position vertically above the cart 100 and/or the cart is moved to a position where it is vertically beneath the mobile hoist. As the mobile hoist nears the cart 100, the pin 190 protruding from the cart engages the slot 194 formed in the plate 192 attached to the mobile hoist. The slot 194 and the pin cooperate to the cart 100 to the desired unloading position underneath the hoist.

The mobile hoist and the wafer assembly are then lowered towards the support of the cart. As the mobile hoist and wafer assembly are lowered towards the support, a portion of the mobile hoist is first received with the channel adjacent its first end. As the width of the channel at its first end is substantially greater than that of the mobile hoist, a user manipulating the mobile hoist is able to position the mobile hoist in the channel with relative ease. The mobile hoist and wafer assembly continue to be lowered, and the angled portions of the guides aid in positioning the mobile hoist and wafer assembly laterally with respect to the cart.

A bottom of the wafer assembly contacts the rollers as the mobile hoist and assembly are further lowered. The bottom of the assembly contacts the tapered portions of the rollers which further aids in the lateral position of the wafer assembly with respect to the cart. Moreover, the positioning of the wafer assembly on the tapered portions elevates the bottom of the wafer assembly above the middle portions of the rollers. This elevation or spacing apart prevents interference or other contact between any structures depending from the bottom of the assembly and the middle portions of the rollers.

After being lowered into the first position on the support, the mobile hoist may be disconnected from the wafer assembly. The cart is then rolled or otherwise moved towards the processing apparatus. As the cart nears the processing apparatus, the pin protruding from the bottom of the cart engages the slot in the plate. The slot and the pin cooperate to guide the cart to an unloading position adjacent the processing apparatus.

Once in the unloading position, the wafer assembly is moved along the rollers into the processing apparatus. As the bottom of the wafer assembly is elevated above the middle portions of the rollers, the cart can be relatively easily moved over the rollers. After unloading, the cart is moved from the unloading position and the process can be repeated for another wafer assembly.

The cart described herein has features which aid in aligning the wafer assembly with respect to the cart. This alignment results in the rapid precise and/or repeatable placement of the wafer assembly on the cart. The cart also has features which aid in positioning the cart with respect to the processing apparatus. These features reduce the amount of time required to transport the wafer assembly from the wire saw to the processing apparatus.

This reduction in time permits the wafers to be transported without being submersed in a tank filled with liquid, as required in prior systems. These prior systems lacked the features of the cart described herein and thus required greater amounts of time to transport the wafer assembly from the wire saw to the processing apparatus. During these longer periods of time, the surfaces of the wafer would dry and react with the atmosphere if left un-submersed. Accordingly, prior systems required the submersion of wafers in a liquid to prevent unwanted chemical reactions with the atmosphere. These prior systems thus incorporated large tanks for holding a liquid in which the wafer assembly was submersed in during transport.

The cart described herein lacks such a submersion tank and the difficulties associated with such a tank. The cart has a significantly reduced mass compared to tanks having a liquid-filled tank. This reduces the amount of force required to move and position the tank adjacent the processing apparatus. Accordingly, a single user is able to move and position the cart. The pin protruding from the bottom also aids the user moving the cart such that a single user is able to position the cart with respect to the mobile hoist and the processing apparatus.

As usage of the cart disclosed herein reduces the amount of time required to position the wafer assembly on the cart and align the cart with respect to the processing apparatus, there is insufficient time for the surfaces of the wafers to dry. Accordingly, the wafer assembly does not have to be submersed in a tank of liquid to protect the surfaces of the wafers from chemical reactions with the atmosphere.

When introducing elements of the present disclosure or the embodiments thereof, the articles “a”, “an”, “the” and “said” are intended to mean that there are one or more of the elements. The terms “comprising”, “including” and “having” are intended to be inclusive and mean that there may be additional elements other than the listed elements.

As various changes could be made in the above without departing from the scope of the present disclosure, it is intended that all matter contained in the above description and shown in the accompanying drawings shall be interpreted as illustrative and not in a limiting sense.

What is claimed is:

1. A cart for transporting wafers from a wire saw to a processing apparatus after the wafers are cut from an ingot, the cart comprising:
a frame having opposing ends and a support sized for receiving a wafer assembly including the wafers;
rollers positioned in the support, wherein the rollers have opposing ends connected to the frame, the rollers having a tapered portion positioned adjacent the ends for guiding the wafer assembly to a first position as the wafer assembly is lowered onto the support of the frame; and
an upright member connected to one of the ends of the frame, the upright member having an alignment member disposed for guiding the wafer assembly to the first position as the wafer assembly is placed on the support of the frame.

2. The cart of claim 1 wherein each roller has first and second tapered portions and first and second ends, and wherein the first and second tapered portions are connected by a middle portion, the first tapered portion disposed adjacent the first end and the second tapered portion disposed adjacent the second end.

3. The cart of claim 2 wherein a diameter of the roller at the first and second ends is greater than a diameter of the roller at the middle portion.

4. The cart of claim 2 wherein the tapered portion of the rollers has a slope, and wherein the slope is disposed to elevate a bottom of the wafer assembly above the middle portion of the rollers when the wafer assembly is in the first position.

5. The cart of claim 1 wherein the upright member extends upwards from the frame and support.

6. The cart of claim 1 wherein the alignment member includes a pair of guides connected to the upright member, wherein the guides and upright member form a channel.

7. The cart of claim 6 wherein the channel has a first end and a second end, the first end disposed farther away from the frame than the second end, the channel having a width at its first end that is greater than a width at its second end.

8. The cart of claim 7 wherein the width of the channel at its first end is greater than a width of a mobile hoist used to transport the wafer assembly from the wire saw to the cart.

9. The cart of claim 1 further comprising a pin protruding from a bottom of the cart, the pin disposed for positioning the cart adjacent a mobile hoist.

10. The cart of claim 9 further comprising a plate having a slot sized for receiving the pin, the plate positioned adjacent the mobile hoist, wherein the slot and the pin cooperate to position the cart adjacent the mobile hoist.

11. A system for transporting wafers to a processing apparatus, the system comprising:
a frame having a support sized for receiving a wafer assembly including the wafers; and
an alignment system connected to the frame, the alignment system disposed for guiding the wafer assembly to a first position as the wafer assembly is lowered onto the support of the frame.

12. The system of claim 11 wherein the alignment system comprises rollers positioned in the support, the rollers having a tapered portion for guiding the wafer assembly to the first position as the wafer assembly is placed on the support of the frame.

13. The system of claim 12 wherein the rollers have opposing ends connected to the frame, and wherein each roller has two tapered portions connected by a middle portion, each of the tapered portions positioned adjacent the ends of the roller, and wherein a diameter of the roller at the tapered portions is greater than a diameter of the roller at the middle portion.

14. The system of claim 13 wherein the tapered portions have a slope, and wherein the slope is disposed to elevate a bottom of the wafer assembly above the middle portion of the rollers when the wafer assembly is in the first position.

15. The system of claim 11 wherein the alignment system comprises an upright member connected to and extending upward from one of the ends of the frame, the upright member having an alignment member disposed for guiding the wafer assembly to the first position as the wafer assembly is place on the support of the frame.

16. The system of claim 15 wherein the alignment member comprises a pair of guides connected to the upright member, wherein the guides and the upright member form a channel.

17. The system of claim 11 further comprising a wafer assembly.

18. A method of positioning a wafer assembly in a first position on a cart for transporting the wafer assembly from a wire saw to a processing apparatus, the wafer assembly including wafers cut from an ingot by the wire saw, the method comprising:
lowering the wafer assembly into contact with an alignment member connected to an upright member of the cart, the alignment member disposed for guiding the wafer assembly to the first position as the wafer assembly is lowered towards the frame; and
placing the wafer assembly onto rollers connected to the frame, the rollers having a tapered portion for guiding the wafer assembly.

19. The method of claim 18 wherein the wafer assembly is lowered into contact with a channel of the alignment member, the channel disposed for guiding the wafer assembly to the first position as the wafer assembly is lowered towards the frame.

20. The method of claim 18 wherein the wafer assembly is placed on rollers each having a pair of tapered portion disposed at opposite ends of the rollers connected by a middle portion, the diameters of the tapered portion being greater then the diameter of the middle portion.
